(19) United States
(12) Patent Application Publication
(10) Pub. No.: US 2024/0340277 A1
(43) Pub. Date: Oct. 10, 2024

(54) DIGITAL KEY BACKUP

(71) Applicant: Hampton Products International Corporation, Foothill Ranch, CA (US)

(72) Inventor: Chasen Beck, Foothill Ranch, CA (US)

(21) Appl. No.: 18/627,307

(22) Filed: Apr. 4, 2024

Related U.S. Application Data
(60) Provisional application No. 63/457,643, filed on Apr. 6, 2023.

(51) Int. Cl. H04L 9/40; B23C 3/35

(52) U.S. Cl. CPC H04L 63/0823; B23C 3/35; B23C 2235/12; H04L 2463/082

(57) ABSTRACT

A key can be provided with a code that uniquely identifies the key or uniquely identifies the lock for which the key is to be used. A server can store information correlating unique key codes for keys with bitting information for those keys. Upon receiving a valid request from a remote device, the server can send bitting information to a remote key making machine and direct the key making machine to make a duplicate key.

### CROSS-REFERENCE TO RELATED APPLICATIONS

This application claims priority to U.S. Provisional Application No. 63/457,643, which was filed Apr. 6, 2023, the entirety of which is hereby incorporated by reference.

### BACKGROUND

The present disclosure relates generally to keys for locks, and more particularly to a registry for keys for locks, and information associated with the key and/or registry and use of the information.

Physical keys have long been used with physical locks to secure a variety of enclosures. The enclosures may be for example homes, yards, offices, desk drawers, file cabinets, or a host of other enclosures. Any individual at any given time may be carrying a variety of keys, for example conveniently grouped on a key ring, to access various enclosures.

Keys may be duplicated for a variety of reasons. For example, keys might be duplicated to guard against the possibility of inadvertent loss or misplacement of a key, or in order to provide keys to other users of the enclosure.

Unfortunately, at times a duplicate key is desired when an original key may be unavailable. This may be particularly the case for locks that are not often utilized but may also simply occur due to misplacement of a key. Moreover, even if the physical key is available for duplication, at times the key duplication process may be inexact, something that may only be apparent well after the duplicate key is made. And keeping track of how many duplicate keys have been made, if such tracking is desired, may be a daunting task.

### BRIEF SUMMARY OF THE INVENTION

In some embodiments a key is provided with a code that includes information regarding the key and a security certificate for validating that the information regarding the key is valid and/or validating that the information regarding the key is coming from a valid source. In some embodiments the code is a QR code or other scannable code. In some embodiments the code is embedded in a near field communication (NFC) tag. In some embodiments the information regarding the key uniquely identifies the key or uniquely identifies the lock for which the key is to be used. In some embodiments the information regarding the key is key bitting information. In some embodiments the QR code or other scannable code, or NFC tag, may be scanned, or read, by a smartphone or other compute device (e.g., tablet, laptop, personal computer, etc.) having a camera and cellular or network communication capability. In some embodiments the server stores information correlating unique key identifiers for keys with bitting information for those keys.

In some embodiments a process is performed, the process including: obtaining a code by a smartphone or other compute device, having cellular or network communication capability, the code including information of a key and a security certificate; transmitting the information of the key and the security certificate to a server, along with an identifier associated with an individual or an account associated with the individual. In some embodiments the smartphone or other compute device obtains the code by scanning a scannable code, and the scanned code may be considered an obtained code. In some embodiments the smartphone or other compute device has a camera. In some embodiments the smartphone or other compute device obtains the code by interrogating an NFC tag. In some embodiments the process further includes determining, by the server, if the security certificate is valid for the information of the key, and in response to that determination, storing the information of the key, or some of it, in information of the account associated with the individual. In some embodiments the process further includes marking, by the server, an indicator that the key has been registered, and, in some embodiments, not allowing registration of the key with other accounts.

In some embodiments the server may receive a request to duplicate a key. The request may identify an account of a user, a key registered to that account, and a key machine which is to duplicate the key. The server may determine if the key machine is a valid key machine, and, if so, provide the key machine the bitting information for the key. In some embodiments the server provides an authentication code, for example a two-factor authentication code, to a compute device associated with the user and to the key machine. In some embodiments the key machine will not duplicate the key absent entry of the code by the user. In some embodiments the key machine notifies the server once the key is duplicated, and the server may store an indication that the key has been duplicated in information of the account of the user.

In accordance with an embodiment the present specification provides a process for use in duplicating a key. The process includes maintaining in memory a key registry having key structural data concerning a key and a unique identifier for the key, the key structural data comprising key bitting information. The process further includes receiving, from a remote device, a key identification data concerning the key and also receiving a user data, and reviewing the key identification data to determine whether it includes a match with the unique identifier on the key registry. The process further includes receiving, from the remote device, a request for duplication of the key, accessing a key registry to locate the key structural data concerning the key, and sending manufacturing instructions to a key making machine. The manufacturing instructions comprise directions to make a duplicate key incorporating the key structural data.

In some embodiment the process additionally comprises validating the request for duplication of the key.

In some embodiments the request for duplication of the key is linked to the user account, and validating the request for duplication of the key comprises verifying that the key identification data is linked to the user account in the key registry. Other embodiments comprise identifying a machine location of the key making machine and receiving a user location from the remote device. Validating the request for duplication of the key can comprise determining that the machine location and the user location are within a threshold distance from one another. In yet other embodiments, validating the request for duplication of the key comprises sending multi-factor authentication information to the remote device and to the key making machine. Further embodiments can additionally comprise receiving a confirmation that the duplicate key was made, and updating the key registry to confirm that the duplicate key was made.

Yet other embodiments comprise receiving a user data, establishing a user account, and linking the key identification data to the user account.

Still other embodiments comprise maintaining a list of valid key making machines and verifying that the key making machine is included in the list of valid key making machines.

In accordance with another embodiment, the present specification provides a method for making a remotely duplicatable key, comprising providing a key structure data to a server system. The key structure data includes key bitting information. The method further includes making the key using the key structure data, providing a key identification concerning the key, linking the key identification to the key structure data and saving the key identification and the key structure data in a key registry. A key code device can be created comprising the key identification. The key and the key code device are combined in a single sealed package so that the key code device goes with the key.

In some such embodiments, creating the key code comprises printing a QR code readable by a computing device. The QR code will have the key identification.

In other such embodiments, creating the key code comprises writing the key code to a NFC tag.

Further embodiments comprise providing a security certificate to verify the key identification.

Another embodiment comprises receiving an initiating transmission from a remote computing device. The initiating transmission has a user identification and the key identification. The process includes linking the user identification to the key structure data in the key register.

A further embodiment comprises closing the key register to linking the key structure data with any other user identification once the key structure data is linked with the user identification.

In another embodiment, making the key using the key structure data comprises transmitting the key structure data from the server system to a key making device.

In accordance with yet another embodiment, the present specification provides a method for managing a physical key information and duplicating the key, comprising obtaining a key identifier associated with a physical key, obtaining a user information, linking the user information with the key identifier, transmitting the user information and linked key identifier to a remote system, and receiving a digital pass key from the remote system. Duplicating such key additionally comprises transmitting a request for duplication of the physical key to the remote system, identifying a selected key making machine, and transmitting a validation concerning the selected key making machine.

In some embodiments, obtaining the key identifier comprises scanning a printed code or querying an NFC tag.

Further embodiments additionally comprise obtaining a machine identifier from the selected key making machine and transmitting the machine identifier to the remote system.

Yet further embodiments comprise obtaining a machine identifier from the selected key making machine and transmitting the machine identifier to the remote system.

Another embodiment comprises transmitting the digital pass key to the selected key making machine.

In yet another embodiment, transmitting the validation comprises transmitting a GPS position that is within a threshold distance from a position of the selected key making machine.

These and other aspects of the invention are more fully comprehended upon review of this disclosure.

### BRIEF DESCRIPTION OF THE DRAWINGS

FIG. 1A is a semi-block diagram of a system useful in maintaining information about keys and/or duplicating keys, in accordance with aspects of the invention.

FIG. 1B is a semi-block diagram of an example system for generating information about keys and manufacturing the keys.

FIG. 2 is a sequence diagram illustrating interactions between system components for operations that may be performed by a system, in accordance with aspects of the invention.

FIG. 3 is a flow diagram of a process for registering a key with a key registry, in accordance with aspects of the invention.

FIG. 4 is a flow diagram of a process for use in duplicating a key, in accordance with aspects of the invention.

FIG. 5 is a flow diagram for providing a key registry server information regarding a key, in accordance with aspects of the invention.

FIG. 6 is a flow diagram for performing key registration operations by a key registry server, in accordance with aspects of the invention.

FIG. 7 is a flow diagram of a process for performing key duplication operations by a key registry server, in accordance with aspects of the invention.

FIG. 8 is a flow diagram of a process for performing key duplication operations by a key machine, in accordance with aspects of the invention.

### DETAILED DESCRIPTION

A user may register a key with a central authority using information regarding the key and a security certificate associated with the information. The key may be a physical key for use with a physical lock, for example a door lock. In some embodiments the user obtains the information regarding the key and the security certificate by scanning a QR code on or provided with the key. The QR code can be included within packaging when the key and an associated lock are initially purchased. The QR code can also be provided on related products, such as attached to a key ring or to the lock body or chassis. In some embodiments the scanning is performed by a smartphone including a camera. In some embodiments the user obtains the information regarding the key and the security certificate by interrogating an NFC tag on or provided with the key. In some embodiments the central authority is a server. In some embodiments the information regarding the key is a unique identifier for the key. In some embodiments the server maintains information regarding physical keys, and the information may include registration information. In some embodiments the information maintained by the server also includes key bitting information.

In some embodiments the server may allow users to create user accounts for storing information regarding keys. The server may do so by way of providing web pages with fillable forms, or by allowing for receipt of information entered into an application (for example an “app”) executing on a smartphone. In registering a key, the smartphone may provide an indication of the user, for example an account ID, the information regarding the key, for example a unique key ID, and the security certificate.

In some embodiments the server utilizes the security certificate to ensure that processing of the information regarding the key may be validly performed. In some embodiments the server associates the information regarding the key with the user account, and marks the key as registered. In some embodiments, once the key is registered with a user account, the key may not be thereafter registered with another user account. In some embodiments the server may send, to the smartphone of the user, information relating to the key. For example, in some embodiments the server may send a digital passkey to the smartphone of the user.

In some embodiments a user may request that a duplicate physical key be made. In some embodiments a smartphone of a user, in response to user inputs, may send a request to the server that a duplicate key be made, along with an identifier of a key machine that is to make the duplicate key. In some embodiments the server determines if the key machine is a valid key machine for making duplicates of the key. If the key machine is a valid key machine, the server may send key type information and key bitting information to the key machine, so that the key machine may make a duplicate key. In some embodiments the server sends a user authentication code, for example a two-factor authentication code, to both the smartphone of the user and the key machine. In some embodiments the key machine is configured to not make the duplicate key unless the user provides the key machine the authentication code. In some embodiments the key machine provides a notification to the server once the duplicate key is made. In some embodiments the server stores information in the user account indicating that the duplicate key has been made.

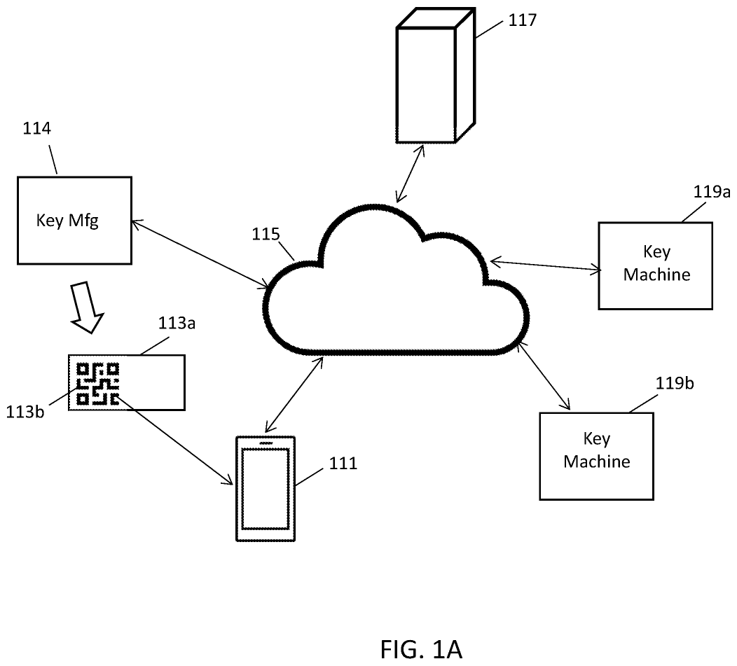

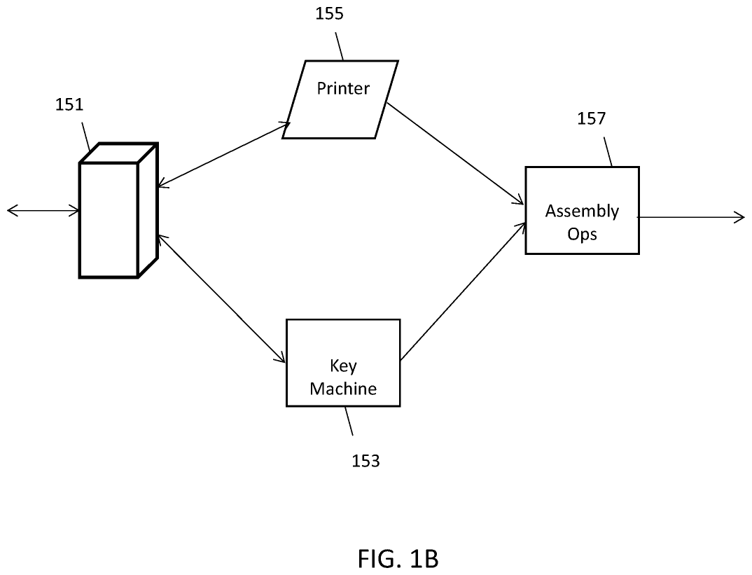

FIG. 1A is a semi-block diagram of a system useful in maintaining information about keys and/or duplicating keys. In FIG. 1A, a smartphone 111 is configured to scan a code 113b associated with a key. In other embodiments the smartphone is configured to interrogate an NFC tag associated with the key, to obtain the code. The code includes information relating to a key and, in some embodiments, a security certificate associated with the key. In some embodiments the information points (directly or indirectly) to information relating to the key and the security certificate associated with the key. The smartphone may scan the code using a camera. The smartphone may include program instructions executing on a processor of the smartphone to interpret and utilize information of the scanned or obtained code. In some embodiments a compute device other than a smartphone may be used to scan the code. For example, in some embodiments a compute device in the form of a tablet computer with a camera, a laptop computer with a camera, or a desktop-type computer having an associated camera may be used instead to scan the code. In some embodiments the smartphone, or other compute device, includes NFC circuitry, and the smartphone or other compute device may obtain the code by interrogating the NFC tag.

In some embodiments the information of the scanned or obtained code includes a unique identifier for the key (or for a lock associated with the key). In some embodiments the information of the scanned or obtained code includes a URL unique to the key (or for a lock associated with the key). In some embodiments the information of the scanned or obtained code includes information of a security certificate associated with the key. In some embodiments the information of the scanned or obtained code includes a URL unique to the security certificate for the key.

In some embodiments the code is a QR code. In some embodiments the code is imprinted on a bow of the key. In some embodiments the code is printed on a tag applied to the key, for example the bow of the key. In some embodiments the code is printed on a tag 113a and placed in packaging provided with the key, for example packaging including a lock and a key to be used with the lock. The QR code, then, can be integrated with or included within the lock/key packaging, and also can be placed in a manner that it is not visible from outside the closed packaging, but is easily located when the packaging is opened, such as by a consumer. In some embodiments the tag and the key are held by a common key ring. The QR code can also be provided physically on a part of the relevant products other than the key, such as being printed on, or printed on a sticker affixed to, a lock body or chassis sold with the key.

In some embodiments the code is in an NFC tag. In some embodiments the NFC tag is adhered to the key, for example to a bow of the key. In some embodiments the NFC tag can be adhered to a related product, such as the lock. The lock can be included within the same package as the key and NFC tag. In some embodiments the NFC tag is placed in packaging provided with the key. In some embodiments the NFC tag and the key are held by a common key ring.

In some embodiments keys are manufactured, and codes are generated, in a key manufacturing facility 114. The key manufacturing facility may include one or more computers or servers configured to generate or store key bitting information in association with key identifiers and possibly other information regarding the keys and, in some embodiments, security certificates for the keys. In some embodiments the one or more computers or servers may provide the key bitting information to a key machine for manufacture of the keys. In some embodiments the one or more computers or server may provide the key identifiers and possibly other information regarding the keys and, in some embodiments security certificates, to a printer or NFC tag writer for printing the information to a tag or writing the information to an NFC tag. The computers and servers are, in some embodiments, coupled to a network 115.

The smartphone 111 is coupled by the network 115 to a server 117. In some embodiments the server 117 may be a server of the key manufacturing facility 114. In some embodiments the server 117 may be some other server, such as server 151 of FIG. 1B. The smartphone is configured to send the information of the scanned or obtained code to the server 117. In some embodiments the program instructions executing on the processor of the smartphone that are involved with scanning of the code include program instructions for sending (or commanding the smartphone to send) the information of the scanned or obtained code to the server. In some embodiments a software application (which may be simply referred to as an “app”) executing on the processor of the smartphone provide for sending (or commanding the smartphone to send) the information of the scanned or obtained code to the server. The network may include one, some, or all of cellular communications networks, data communications networks, and/or the Internet. The network may be a wired network or a wireless network, or include wired and wireless portions.

The server 117 is configured to maintain a key registry and perform processes associated with the key registry. The processes associated with the key registry may include maintaining user accounts, marking keys as registered and associating keys with user accounts, updating key related information, providing key information to user compute devices, and providing key duplication-related information to key machines.

In some embodiments the key registry includes a plurality of user accounts. A user account may specify an individual or entity as an account holder, along with information regarding keys associated with the user account. In some embodiments a user may set up an account by providing the key registry information regarding the user. The information regarding the user may be provided, for example, through use of fill-in web forms provided by the server 117 to a compute device of the user, or by way of the app downloaded to and executing on the compute device of the user. In some embodiments the server is configured to provide, in response to receiving information of the scanned or obtained code, a request to the sending compute device to log-in to a user account of the key registry or to create an account with the key registry. In some embodiments the server may be configured to only do so if a security certificate of the information of the scanned or obtained code indicates that the scanned or obtained code is a valid scanned or obtained code. In some embodiments the user accounts include information as to the identity of the account holder, keys registered to the user account, number of duplicate keys for each key, and persons permitted to create duplicate keys for each key.

In some embodiments the server 117 is configured to perform processing to associate a key with a user account upon receiving the information of the scanned or obtained code and an indication of a user account in which to register the key. In some embodiments the information of the scanned or obtained code includes a unique identifier for the key (or lock associated with the key) and a security certificate. In some embodiments the security certificate is a security certificate unique to the key (or lock associated with the key). In some embodiments the security certificate is common to a set of keys (or a set of locks associated with different keys). In some embodiments the server is configured to associate the key with the user account only if the security certificate is a valid security certificate.

In some embodiments the server also maintains a list (or other data structure) identifying keys that are registered. In such embodiments, the server may be configured to determine if the key identified by the information of the scanned or obtained code is already registered, and associate the key with the user account only if the key is not already registered. The server may thereafter modify the list identifying keys that are registered to include the key.

In some embodiments the server also maintains key bitting information for keys for which codes for scanning have been generated. The key bitting information generally includes information as to depths of cuts and their positions along a key blade. In some embodiments the key bitting information may vary in meaning with respect to different key types or keys associated with different lock manufacturers. Accordingly, in some embodiments the server additionally maintains information for each key indicating a type and/or manufacturer for the key, and can include structural and model characteristics pertaining to the key. For convenience, reference to key bitting information herein shall generally include information indicating a type or manufacturer for the key, unless the context indicates otherwise. In some embodiments the server associates with a user account the key bitting information for a key registered to that user account.

In some embodiments, upon registering a key with a user account, or upon a request by the user (by way of a user compute device), the server is configured to provide a digital passkey to the user compute device. In some embodiments the digital passkey includes the unique identifier for the key. In some embodiments the digital passkey includes the key bitting information for the key. In some embodiments the digital passkey includes an identifier for the user account.

In some embodiments the server is configured to provide key bitting information to key machines 119a,b so that the key machines may duplicate registered keys. The key machines are machines that prepare duplicate keys. In the embodiment of FIG. 1A, the key machines 119a, b are network capable key machines, with the key machines coupled to the server 117 (and in some embodiments the smartphone 111) by way of the network 115. The key machines 119a, b may therefore provide information to the server 117, and receive information from the server 117. The key machines may be located, for example, in hardware stores or other locations, some of which may be frequented by the public.

In some embodiments the server 117 is configured to provide the key bitting information for a key to a key machine upon receiving a request from a user compute device identifying the key, the user account to which the key is registered, and an identification of the key machine. Of course, in various embodiments the user is required to provide a password or similar verification information along with or prior to the request. In some embodiments the key machine may have a printed number or alphanumeric code identifying the key machine on or near a surface of the key machine, which the user may enter into a data entry field of a web page or app display of the smartphone. In some embodiments the key machine may have a readable or scannable feature that provides the identification of the key machine to the smartphone, or vice versa. The readable or scannable feature may be in the form of a QR code, an NFC tag, a BLE beacon, an RFID tag, or some other readable or scannable feature.

In some embodiments the server also maintains a list (or other data structure) indicating valid key machines, e.g., key machines that may be used to duplicate registered keys. In some embodiments the server is configured to determine whether the key machine is a valid key machine, and to not provide key bitting information to key machines that are not valid key machines.

In some embodiments the server is also configured to provide an authentication code, for example a two-factor authentication code, to the compute device of the requesting user and to the key machine. In some embodiments the key machine is configured to not prepare the duplicate key unless the user enters the authentication code into a user data entry device of the key machine, or satisfies some other multi-factor authentication process. In some embodiments the server is, instead or in addition, configured to receive information indicative of location information of a smartphone of the user, and to provide a message to the key machine indicating that the user is proximate to the key machine, with the key machine instead or in addition, configured to not prepare the duplicate key unless user is proximate the key machine. In some embodiments the server is configured to receive GPS location of smartphone, with the server storing GPS locations of key machines, with the server configured to determine if the user is proximate to the key machine based on that information. In some embodiments the server may be configured to receive, in addition or instead, other information indicative of location of the smartphone of the user, such as location information derived from Wi-Fi nodes, cellular communication nodes, or other devices.

In some embodiments the key machine is configured to provide the server a notification that the duplicate key has been made once the duplicate key has been made. In some embodiments the server is configured to maintain a record of duplicate keys made, for example on a registered key-by-key basis, and to store that record in association with the user account.

FIG. 1B is a semi-block diagram of an example part of the key manufacturing facility 114 of FIG. 1A. As shown in FIG. 1B, one or more computers or servers 151 are configured to generate or store key bitting information in association with key identifiers and possibly other information regarding the keys and, in some embodiments, security certificates for the keys. The computers and servers 151 may be coupled to a network, for example the Internet. In some embodiments the one or more computers or servers 151 may provide the key bitting information to a key machine 153 for manufacture of the keys. In some embodiments the one or more computers or server may provide the key identifiers and possibly other information regarding the keys and, in some embodiments security certificates, to a printer 155 or NFC tag writer for printing the information to a tag or writing the information to an NFC tag. In some embodiments the one or more computers or servers may also provide information regarding the key to other servers, for example the server 117 of FIG. 1A. In some embodiments the one or more computers or servers 151 may do so in response to receiving a notification from the key machine 153 that the key has been manufactured. Information that has been printed or written to an NFC tag can be combined with the manufactured key during assembly operations 157. For example, a printed QR code (corresponding to key identifiers) can be included in packaging, or a key ring, or even attached to a lock body or chassis that is sold or otherwise distributed with the manufactured key.

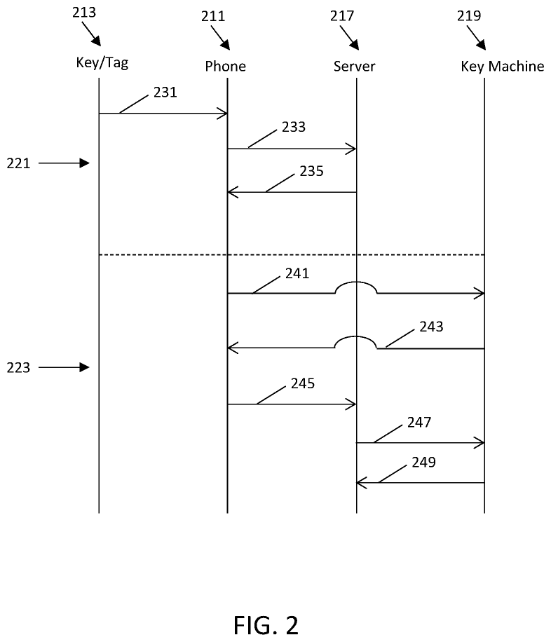

FIG. 2 is a sequence diagram illustrating interactions between system objects for operations that may be performed by a system. The sequence diagram of FIG. 2 illustrates two sequences. A first sequence 221 relates to registration of a key with a key registry. A second sequence 223 relates to duplication of a registered key. In some embodiments the system is the system of FIG. 1. In some embodiments the system objects include a smartphone (or other user compute device) and a server. In some embodiments the system objects include a smartphone (or other user compute device), a server, and a key machine.

For the registration of the key with a key registry, a smartphone 211 receives 231 key related information from a key or a tag 213 associated with the key. The key related information may include, for example, a unique identifier for the key (or a lock associated with the key). In some embodiments the key related information may also include a security certificate associated with the key (or lock associated with the key). In some embodiments the key related information may also include an identifier for a network location, for example a URL for accessing a key registry.

The smartphone provides 233 the unique key ID and, in some embodiments, the security certificate to a server 217 providing the key registry. Generally the smartphone also identifies a user account with which the key registration is to be associated. The server determines if the key has not been registered to another user account and, if applicable, confirms validity of the security certificate. If the key has already been registered to another user account or, if applicable, the security certificate is not valid, the server takes no further action to register the key, If, however, the key has not been registered and, if applicable, the security certificate is valid, the server registers the key with the user's account.

The server sends 235 information of a digital passkey to the smartphone 211. The digital passkey may include information relating to the key and/or registration of the key.

For duplication of a registered key, optionally the smartphone 211 of a user having a registered key requests 241 identification information from a key machine 219, and the key machine provides 243 key machine identification information to the smartphone. In some embodiments the key machine may instead have a placard or other visible information providing the key machine identification information, and the user may enter that information into the smartphone, for example using a web fillable form or data entry fields of an app executing on the smartphone. In some embodiments the key machine may provide the key machine identification information to the smartphone without need of a request from the smartphone. For example in some cases the key machine may have a scannable or readable code including the key machine identification information, which may be scanned or read by the smartphone.

The smartphone sends 245 a message to the server requesting duplication of a key. The message may include the unique identifier for the key (or lock associated with the key), the user account to which the key is registered, and the key machine identification information for the key machine proposed for duplication of the key. Of course, in various embodiments the smartphone may also have to provide a password or the like, either with the request or as part of logging onto the user account as a preliminary to the request.

The server 117 determines if the request is from a user who has a user account to which the key is registered, and if the identified key machine is a valid key machine 119a, b. For the latter, the server may maintain or have access to a list of valid key machines. The valid key machines may be, for example, key machines that are authorized to make duplicate keys. If the request is proper, the server provides 247 information sufficient for the key machine to make the duplicate key. The information may be structural information about the key, for example, key bitting information. In some embodiments the server may also provide both the smartphone and the key machine an authentication code, entry of which the key machine may require before making the duplicate key. The authentication code may be considered a two-factor authentication (2FA) code in some embodiments. In some embodiments the server may also, or instead, receive location information for a smartphone of the user and compare that information with key machine location information to determine if the user is proximate the key machine, and to notify the key machine as to whether the user is proximate the key machine. In some embodiments the user being proximate the key machine may be required by the key machine before the key machine makes the duplicate key.

In some embodiments, after making the duplicate key, the key machine may provide 249 a confirmation to the server that the duplicate key has been made. In some embodiments the server may store information in the user account indicating numbers of duplicate keys made, for example on a key-by-key basis.

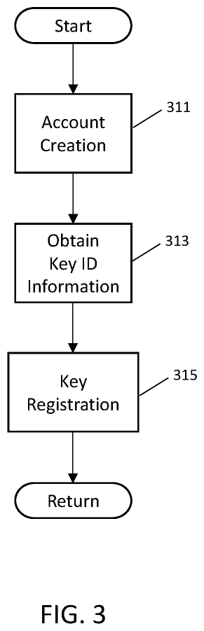

FIG. 3 is a flow diagram of a process for registering a key with a server. In some embodiments the process is performed by a system, for example the system of FIG. 1A. In some embodiments the process, or portions of the process, is performed by a server, for example the server of FIG. 1A. In some embodiments the process, or portions of the process, is performed by one or more electronic devices, for example one or more of the electronic devices of FIG. 1A. In some embodiments the process is performed by one or more processors, for example as configured by program instructions.

In block 311, the process creates a user account. In some embodiments a server creates the user account. In some embodiments the server is a key registry server. In some embodiments the server creates the user account using information provided over a network by a smartphone or other compute device of a user. In some embodiments the server provides a web page with fillable forms to the smartphone, using a secure connection in some embodiments. The smartphone may receive user entries for the fillable forms, and the smartphone may provide information of the user entries to the server. In some embodiments the server provides fillable forms to the smartphone via application software installed on the smartphone. In some embodiments at least some fillable forms can be part of the application software. In some embodiments the application communicates with the server using a secure connection. The application on the smartphone may receive user entries for the fillable forms, and the application on the smartphone may provide information of the user entries to the server. In some embodiments the smartphone may receive a link and/or be directed to such website or application for creating the account by scanning a QR code or interrogating an NFC tag associated with the key and lock. In some embodiments the scanning of the QR code or interrogating the NFC code may direct the smartphone to a product landing website page with links to the URLs for creating the account, to download the software application, and other useful links such as for downloading a third-party passkey wallet application and a technical support website. In some embodiments when the smartphone is directed to one of the sources for creating a key registration account, the needed information about the user, such as personal information, may be entered using a fillable digital form accessed with the smartphone. In some embodiments the created account may be further customized with additional details after the creation of the account. In some embodiments the server retains the information about the created account. In some embodiments the server may receive additional contacts to be added to the account, where the key information and digital key to be registered with the account may be shared with such contacts.

In block 313, the process obtains key identification information. In some embodiments the server may obtain key ID information pertaining to the key that the user intends to register. In some embodiments the smartphone may prompt the user to provide key information after creating an account. In some embodiments the key information may include a security certificate, a unique key identifier or encrypted serial number, and structural and model characteristics pertaining to the key that is being registered. In some embodiments the structural and model key information may include keyway type, bitting information, key material composition, key color, key blank serial number, key blank manufacturer, key blank model number, the type of lock used with the key, product brand and model, manufacturer and factory of origin, date and time of manufacture, time of last key machine calibration, and other information pertaining to the key that is being registered and/or its corresponding lock. In some embodiments the process may prompt the user to enter information such as a key name, a room associated with key, a household associated with the key, or other information. In some embodiments, however, the server may already store or have access to such information stored in association with the key ID. For example, the server may have access to a database or other data structure storing such information, some or all of it, with the information retrievable by key ID. In some embodiments the smartphone may provide the key information to the server by scanning a QR code associated with the key that is being registered with the server using the camera of the smart phone.

In block 315, the process registers the key information in the server and linked with the account of the user. In some embodiments the server may validate the security certificate and decrypt the unique key identifier associated with the key that is being registered, which such information may be as provided in block 313. In some embodiments the security certificate is a security certificate unique to the key (or lock associated with the key). In some embodiments the security certificate is common to a set of keys (or a set of locks associated with different keys). In some embodiments the server is configured to associate the key with the user account only if the security certificate is a valid security certificate. In some embodiments the server may look up the unique key identifier and assign it to the user account. In some embodiments the server may then mark the unique key identifier as registered and no longer allow the key and the key information to be registered to any other accounts. In some embodiments the structural characteristics of the key, described in block 313, may be transferred to the server and linked with the account of the user after the server assigns the unique key identifier to the account. In some embodiments the server may already possess some or all of the structural characteristics of the key and/or associated lock and merely link such characteristics with an identifier for the key in the user account. The server may have a copy of the digital key for duplication by a key machine when requested by the user, for example by using a smartphone to access the created account.

In some embodiments the digital copy of the key may be transferred and linked with a third-party passkey wallet application, such as Google or Apple Wallet. In some embodiments the server may encrypt the key information sent to the third-party passkey wallet and the passkey wallet application may store the key information in the form of a QR code, NFC data, or other electronically readable data, for example for use as a Bluetooth enabled key. In some embodiments the server may share a copy of the digital key with the contacts linked with the user account. In some embodiments multiple keys may be registered with a user account.

The process thereafter returns.

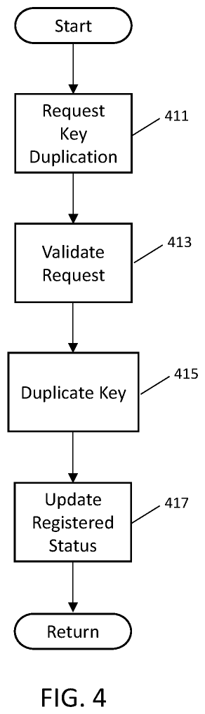

FIG. 4 is a flow diagram of a process for use in duplicating a key. In some embodiments the process is performed by a system, for example the system of FIG. 1A. In some embodiments the process, or portions of the process, is performed by a server, for example the server of FIG. 1A. In some embodiments the process, or portions of the process, is performed by one or more electronic devices, for example one or more of the electronic devices of FIG. 1A. In some embodiments the process is performed by one or more processors, for example as configured by program instructions.

In block 411, the process requests key duplication. In some embodiments a request for key duplication may be initiated by way of a smartphone accessing a webpage or a software application associated with a key registry server or a third-party passkey wallet application. In some embodiments the smartphone, for example in response to a user input on the smartphone, may send a request to the server for the initiation of the key duplication. In some embodiments the smartphone may establish a secure connection to the server using the webpage or software application. In some embodiments the smartphone may first need to provide login information for the user account to which the key is registered prior to processing of a request for key duplication. In some embodiments the smartphone may identify a key machine for the duplication of the key, for instance via using the created user account or manual pairing of the smartphone with the key machine.

In block 413, the process validates the request for key duplication. In some embodiments the server may search for and validate the unique key identifier associated with the key to be duplicated. In some embodiments the unique key identifier may be linked to the account of the user, where the server retrieves the unique key identifier from the user account. In some embodiments the unique key identifier may be linked to a digital passkey wallet of a user stored in a third-party software application, where the server retrieves the unique key identifier from the passkey wallet. In some embodiments the server may validate that the user selected key machine is a valid key duplication machine. In some embodiments an identifier of the key machine may be sent to the server for the validation. In some embodiments the identifier may be sent to the server using the smartphone or alternatively the key machine itself.

In block 415, the process duplicates the key. In some embodiments the server may send encrypted key bitting information to the user selected key machine after the server validates the key duplication request and, in some embodiments, also the key machine. In some embodiments other structural information for the duplication of the key may be sent to the key machine, such as the structural key information described elsewhere herein. In some embodiments the server sends a user authentication code, for example a two-factor authentication code, to both the smartphone of the user and the key machine. In some embodiments the key machine is configured to not make the duplicate key unless the user provides the key machine the authentication code. In some embodiments the two-factor authentication code may be provided to the user smartphone. In some embodiments the two-factor authentication code may be user personal information, such as phone number, email address, pin code, or security questions. In some embodiments such personal information may have been retrieved by the server when the user first created an account with the server. Alternatively, in some embodiments the server may create a token (QR code, out of band audio signal or similar) that can be read, for example from a display of the smartphone, by the key machine. In some embodiments the key machine manufactures the duplicate key and afterwards sends a message to the server that the manufacturing of the duplicate key has been performed

In block 417, the process updates registration status of the key. In some embodiments the key machine may send a notification to the server, and in some embodiments the smartphone, that the physical duplicate key was created successfully. In some embodiments the server may apply rules relating to the registration of the key. The rules may, for example, mark the key as no longer available for further physical key manufacturing, or limit the number of times the key may be duplicated, or simply maintain a record as to how many times the key has been duplicated. The process thereafter returns.

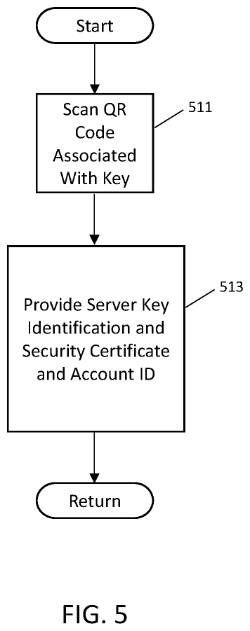

FIG. 5 is a flow diagram of a process for providing a key registry server information regarding a key. In some embodiments the process is performed by a system, for example the system of FIG. 1A. In some embodiments the process, or portions of the process, is performed by a server, for example the server of FIG. 1A. In some embodiments the process, or portions of the process, is performed by one or more electronic devices, for example one or more of the electronic devices of FIG. 1A. In some embodiments the process is performed by one or more processors, for example as configured by program instructions. In some embodiments the process is performed by a user compute device. In some embodiments the user compute device is a smartphone. In some embodiments the process performs operations of block 313 of the process of FIG. 3.

In block 511, the process scans a code associated with the key. In some embodiments the code includes information regarding the key and a security certificate associated with the information. The code associated with the key may be on or attached to the key, the lock, or the packaging of the key and the lock. In some embodiments a user account may first need to be created with the server to link the key information with the user account. In some embodiments the code may be a QR code. In some embodiments the information regarding the key may include a unique key (or lock) identifier. In some embodiments the information regarding the key may include an encrypted serial number of the key. In some embodiments the information regarding the key may include structural information pertaining to the key.

In block 513, the process provides the server the information regarding the key, or some of it, the security certificate in some embodiments, and an account ID. In some embodiments the smartphone may transmit to the server a security certificate, a unique key identifier or encrypted serial number, and, in some embodiments, structural information pertaining to the key by scanning the QR code associated with the key. In some embodiments the server may already possess at least some of the structural information of the key, and the server may link such information to the key that is being registered. In some embodiments the structural information pertaining to the key may include at least key bitting information. In some embodiments the server may be provided with the account ID of the user account to which the key information is being linked.

The process thereafter returns.

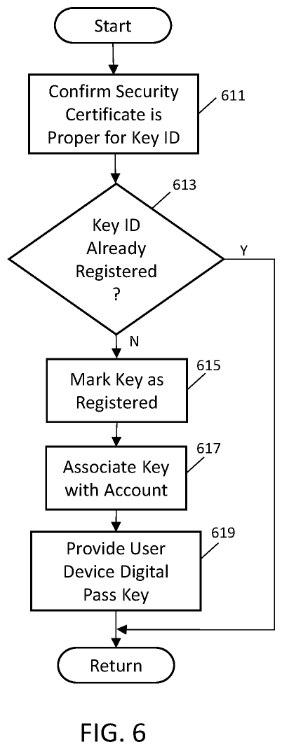

FIG. 6 is a flow diagram of a process for performing key registration operations by a key registry server. In some embodiments the process is performed by a system, for example the system of FIG. 1A. In some embodiments the process, or portions of the process, is performed by a server, for example the server of FIG. 1A. In some embodiments the process, or portions of the process, is performed by one or more electronic devices, for example one or more of the electronic devices of FIG. 1A. In some embodiments the process is performed by one or more processors, for example as configured by program instructions. In some embodiments the process performs operations of block 315 of the process of FIG. 3.

In block 611, the process confirms a received security certificate is proper for a received key ID, the key ID identifying a key. In some embodiments the server utilizes the security certificate of the key to ensure that processing of the information regarding the key may be validly performed. In some embodiments the server validates the security certificate and decrypts a unique key identifier, or encrypted serial number, that may have been sent by a smartphone that scanned a code associated with the key that is being registered.

In block 613, the process determines whether the key ID has already been registered. In some embodiments the server searches stored data to find whether the unique key identifier associated with the key has been registered with another account or not. If the server does not find the unique key identifier registered with another account, then the process proceeds forward to block 615. If the server finds the unique key identifier registered with another account, then the process returns, without registering or further registering the key.

In block 615, the process stores an indication that the key is registered. In some embodiments once the key is registered with the user account, the key may not thereafter be registered with another user account. In some embodiments the key information registered with the user account may be transferred to another user account.

In block 617, the process associates the information regarding the key with the user account. In some embodiments the server associates the information regarding the key with the user account after marking the key as registered. In some embodiments the server searches or receives key information to associate with the user account. In some embodiments the server associates the unique key identifier of the registered key with the user account. In some embodiments the server associates the structural features of the registered key, such as key bitting information and other features described elsewhere herein, with the user account.

In block 619, the process provides the user compute device a digital pass key. In some embodiments the server maintains a copy of the digital pass key and provides the smartphone with a copy of the digital pass key also. In some embodiments the digital pass key may be accessed through the user account using a software application or a webpage. In some embodiments the digital pass key may be accessed through or transmitted to a third-party digital passkey wallet. In some embodiments the digital pass key may be emailed to the user by the server. In some embodiments the digital pass key may be in the form of a QR code. In some embodiments the digital pass key may contain the unique key identifier and the structural information of the associated key described elsewhere herein.

The process thereafter returns.

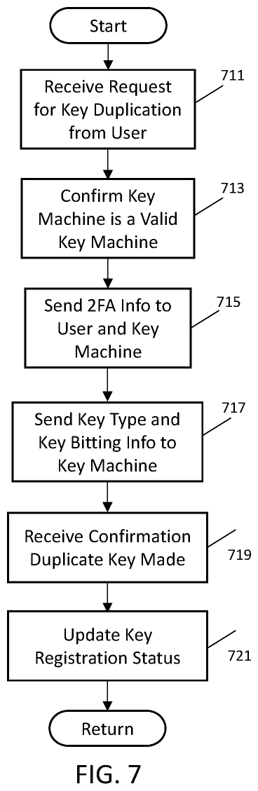

FIG. 7 is a flow diagram of a process for performing key duplication operations by a key registry server. In some embodiments the process is performed by a system, for example the system of FIG. 1A. In some embodiments the process, or portions of the process, is performed by a server, for example the server of FIG. 1A. In some embodiments the process, or portions of the process, is performed by one or more electronic devices, for example one or more of the electronic devices of FIG. 1A. In some embodiments the process is performed by one or more processors, for example as configured by program instructions. In some embodiments the process of FIG. 7 performs operations of blocks 413 and 417 of the process of FIG. 4.

In block 711, the process receives a request for key duplication. In some embodiments the request is received from a user compute device, for example a user smartphone. In some embodiments the request for key duplication identifies the key to be duplicated, identifies the user account to which the key is registered, and/or identifies a key machine to perform the key duplication. In some embodiments the request for key duplication may have been initiated by the smartphone accessing a webpage or a software application associated with a key registry server or a third-party passkey wallet application. In some embodiments the smartphone may send a request to the server for the initiation of the key duplication in response to receiving a user input from a user. In some embodiments the smartphone may establish a secure connection to the server using the webpage, software application, or third-party passkey wallet. In some embodiments the smartphone may first perform login operations to the user account to which the key for duplication is registered. In some embodiments the request for key duplication may be received from a key machine, for example after information of a digital pass key is provided to the key machine. In some embodiments information of the digital pass key may have been presented to a scanner of the key machine. In some embodiments the information of the digital pass key may be in the form of a QR code displayed on a display of the user smartphone. In some embodiments the server may validate that the request for key duplication is valid. In some embodiments the server may validate that the request is valid by determining that the requestor is the user to whom the key is registered. In some embodiments the server may search for and validate the unique key identifier associated with the key to be duplicated.

In block 713, the process confirms the key machine is a valid key machine. In some embodiments the smartphone may be used to identify a key machine for the duplication of the key, for instance via using the created user account or manually pairing with the key machine. In some embodiments the server may validate that the user selected key machine is a valid key duplication machine. In some embodiments an identifier of the key machine may be sent to the server for the validation. In some embodiments the identifier may be sent to the server using the smartphone or the key machine itself. In some embodiments the server maintains a list of valid key machines, and determines if the identified key machine is on the list of valid key machines.

In block 715, the process sends an authentication code to the user and to the key machine. In some embodiments the server sends a user authentication code, for example a two-factor authentication code, to both the smartphone of the user and the key machine. In some embodiments the key machine is configured to not make the duplicate key unless the user provides the key machine the authentication code. In some embodiments the two-factor authentication code may be all done on the user smartphone. In some embodiments the two-factor authentication may be done using the user personal information, such as phone number, email address, pin code, or security questions. In some embodiments such personal information may have been retrieved by the server when the user first created an account with the server. Alternatively, in some embodiments the server may create a token (QR code, out of band audio signal or similar) that can be read by the key machine client using the user smartphone, or the server may provide the key machine information as to proximity of the user to the key machine.

In block 717, the server 117 sends key type and key bitting information to the key machine. In some embodiments the server may send encrypted key bitting information to the user selected key machine after the server validates the key duplication request and also the key machine. In some embodiments other structural information for the duplication of the key may be sent to the key machine by the server, such as the structural key information described elsewhere herein.

In block 719, the process receives confirmation that the duplicate key has been made. In some embodiments the server receives from the key machine the confirmation that the duplicate key has been made. In some embodiments the key machine sends a notification to the server and to the smartphone that the physical duplicate key was created successfully.

In block 721, the process updates key registration status. In some embodiments the server may store information associated with the key and the user account to indicate a number of duplicate keys made. In some embodiments the server may mark the key as no longer allowed to be duplicated.

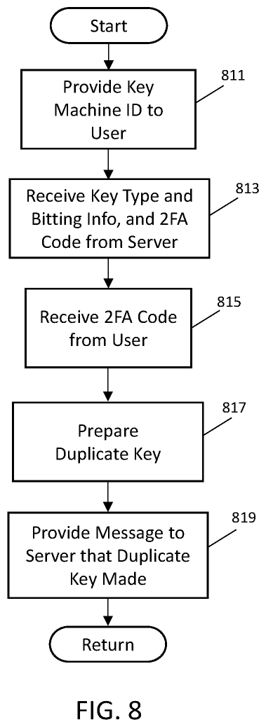

FIG. 8 is a flow diagram of a process for performing key duplication operations by a key machine. In some embodiments the process is performed by a system, for example the system of FIG. 1A. In some embodiments the process, or portions of the process, is performed by a key machine, for example one of the key machines of FIG. 1A. In some embodiments the process, or portions of the process, is performed by one or more electronic devices, for example one or more of the electronic devices of FIG. 1A. In some embodiments the process is performed by one or more processors, for example as configured by program instructions. In some embodiments the process performs operations of block 415 of the process of FIG. 4.

In block 811, the process provides a key machine ID to a user. In some embodiments the smartphone 111 of the user may request the key machine ID from the key machine. In some embodiments the smartphone may be used to identify a key machine and pair with the key machine to duplicate the key. In some embodiments the identifying and paring may be done using the created user account or by manually pairing with the key machine. In some embodiments the key machine may provide and display the key machine identifier in a form of a code, for example a QR code that can be scanned by the user smartphone and for example transmitted by the smartphone to the server for validation. In some embodiments the key machine may provide the key machine ID through use of an NFC tag or BLE beacon associated with the key machine. In some embodiments the user smartphone may request for the key machine to provide the identifier via the server, where the server may validate that the identifier is for the user selected key machine.

In block 813, the process receives a key type and bitting information for the key to be duplicated, and, in some embodiments, an authentication code from a server. In some embodiments the server is a server maintaining a key registry, with the key registered in the key registry. In some embodiments the server sends the key machine the structural information about the key, such as the encrypted key bitting information and other structural features described elsewhere herein. In some embodiments the server sends a user authentication code, for example a two-factor authentication code, to both the smartphone of the user and the key machine.

In optional block 815, the process receives the authentication code from the user and/or information regarding proximity of the user to the key machine. In some embodiments the key machine is configured to not make the duplicate key unless the user provides the key machine the authentication code and/or the user is proximate the key machine. In some embodiments the user provides the authentication code to the key machine either directly or indirectly via the server by using the user smartphone.

In block 817, the process prepares the duplicate key. In some embodiments the key machine manufactures the duplicate key according to the structural key information provided by the server.

In block 819, the process provides a message to server that duplicate key has been made. In some embodiments the key machine sends a notification to the server that the physical duplicate key was created successfully, for example to allow the server to update the status of the registered key. In some embodiments the key machine may also send a notification to the user smartphone that the duplicate key has been made.

Although the invention has been discussed with respect to various embodiments, it should be recognized that the invention comprises the novel and non-obvious claims supported by this disclosure.

What is claimed is:

1. A method for making a remotely duplicatable key, comprising:
providing a key structure data to a server system, the key structure data including key bitting information;
making a key using the key structure data;
providing a key identification concerning the key;
linking the key identification to the key structure data and saving the key identification and the key structure data in a key registry;
creating a key code device comprising the key identification; and
combining the key and the key code device in a single sealed package so that the key code device goes with the key.

2. The method of claim 1, wherein creating the key code device comprises printing a QR code readable by a computing device, the QR code having the key identification.

3. The method of claim 1, wherein creating the key code device comprises writing the key identification to a NFC tag.

4. The method of claim 1, wherein the key identification comprises a security certificate.

5. The method of claim 1, comprising receiving an initiating transmission from a remote computing device, the initiating transmission having a user identification and the key identification, and linking the user identification to the key structure data in the key register.

6. The method of claim 5, comprising closing the key register to linking the key structure data with any other user identification once the key structure data is linked with the user identification.

7. The method of claim 1, wherein making the key using the key structure data comprises transmitting the key structure data from the server system to a key making device.

8. A method for managing a physical key information and duplicating the key, comprising:
obtaining a key identifier associated with a physical key;
obtaining a user information;
linking the user information with the key identifier;
transmitting the user information and linked key identifier to a remote system;
receiving a digital pass key from the remote system;
transmitting a request for duplication of the physical key to the remote system;
identifying a selected key making machine; and
transmitting a validation concerning the selected key making machine.

9. The method of claim 8, wherein obtaining the key identifier comprises scanning a printed code or querying an NFC tag.

10. The method of claim 8, comprising obtaining a machine identifier from the selected key making machine and transmitting the machine identifier to the remote system.

11. The method of claim 8, comprising transmitting the digital pass key to the selected key making machine.

12. The method of claim 8, wherein transmitting a validation comprises transmitting a GPS position that is within a threshold distance from a position of the selected key making machine.

13. A process for use in duplicating a key, comprising:
maintaining in memory a key registry having a key structural data concerning a key and a unique identifier for the key, the key structural data comprising key bitting information;
receiving, from a remote device, a key identification data concerning the key and a user data;
reviewing the key identification data received from the remote device to determine whether it includes a match with the unique identifier on the key registry, and linking the user data to the key structural data on the key registry only if the key identification data includes a match with the unique identifier;
receiving, from the remote device, a request for duplication of the key;
accessing a key registry to locate the key structural data concerning the key; and
sending manufacturing instructions to a key making machine, the manufacturing instructions comprising directions to make a duplicate key incorporating the key structural data.

14. The process of claim 12, additionally comprising validating the request for duplication of the key.

15. The process of claim 13, wherein the request for duplication of the key is linked to the user account, and wherein validating the request for duplication of the key comprises verifying that the key structural data is linked to the user account in the key registry.

16. The process of claim 13, comprising identifying a machine location of the key making machine and receiving a user location from the remote device, and wherein validating the request for duplication of the key comprises determining that the machine location and the user location are within a threshold distance from one another.

17. The process of claim 13, wherein validating the request for duplication of the key comprises sending multi-factor authentication information to the remote device and to the key making machine.

18. The process of claim 13, additionally comprising receiving a confirmation that the duplicate key was made, updating the key registry to confirm that the duplicate key was made, and tracking how many of the duplicate keys were made.

19. The process of claim 12, comprising maintaining a list of valid key making machines and verifying that the key making machine is included in the list of valid key making machines.
